(19) United States
(12) Patent Application Publication
(10) Pub. No.: US 2005/0249846 A1
(43) Pub. Date: Nov. 10, 2005

(54) Trehalose and suppression of off-flavor notes

(76) Inventors: Jeffrey C. Evans, St. Michael, MN (US); Brian D. Guthrie, Chanhassen, MN (US); John F. Sweeney, St. Michael, MN (US); Scott J. Eilert, Wichita, KS (US)

Correspondence Address: CARGILL, INCORPORATED, LAW/24, 15407 MCGINTY ROAD WEST, WAYZATA, MN, 55391, US

(21) Appl. No.: 11/061,015

(22) Filed: Feb. 18, 2005

Related U.S. Application Data
(60) Provisional application No. 60/546,031, filed on Feb. 19, 2004.

(51) Int. Cl. A23L 1/31

(52) U.S. Cl. 426/321

(57) ABSTRACT

A composition including meat, trehalose, and one or more preservatives, wherein the compositions exhibits less off-flavor than the same composition without trehalose. Also included is a method using trehalose to mask off-flavors caused by preservatives and/or anti-microbials in meat products.

This application claims the benefit of U.S. Provisional Application No. 60/546,031, filed Feb. 19, 2004, which is hereby incorporated by reference.

### FIELD OF INVENTION

Embodiments of the invention relate to the use of trehalose for masking off-flavors of meat, such as astringent and/or bitter off-flavors, and meat products having reduced off-flavors as compared to meat products without trehalose. More specific embodiments of the invention relate to the use of trehalose for masking the off-flavors of ready-to-eat meat associated with antimicrobials, and ready-to-eat meat products incorporating trehalose.

### BACKGROUND

Sodium lactate and potassium lactate are antimicrobials that have been used to control spoilage and ensure the safety of cooked, ready-to-eat meat products. In addition, it's been discovered that lactate salts are more effective toward certain microbials, such as Listeria monocytogenes, when combined with sodium diacetate. Thus, the usage of lactate/diacetate salts is expected to rise in cooked, ready-to-eat meat products.

One drawback to the use of lactate/diacetate salts is their commonly occurring off flavor, such as bitterness, and their commonly occurring astringency. The issue is especially problematic with the potassium salt forms. Thus, meat processors must try to strike a balance between the flavor of the product and its food safety. This means that some off-flavors may be unavoidable if higher antimicrobial dosages are required.

### DESCRIPTION

The inventors have discovered that certain disaccharides, such as trehalose, can be used as a flavor enhancer or to mask off-flavors in meat products. Embodiments according to the invention include compositions comprising a disaccharide, such as trehalose, and certain preservatives, such as sodium lactate, potassium lactate, and sodium diacetate. In some embodiments, compositions according to the invention have reduced the off-flavor in cooked meat commonly resulting from such preservatives.

Certain aspects of the invention are directed at compositions resulting from the discoveries. Certain other aspects are directed at food compositions resulting from the discoveries. Other aspects are directed at methods resulting from the discoveries for treating uncooked meat.

Still other aspects are directed at using trehalose to reduce off-flavor of a cooked food composition. Other aspects are directed at food compositions resulting from the various methods of the invention. Still other aspects are directed at antimicrobial agents resulting from the discoveries.

For certain specific embodiments, the invention involves the use of trehalose to mask astringency and off flavors, such as bitterness, that commonly accompany the use of lactate and diacetate salts in cooked meat.

In some embodiments, the invention can increase meat formulation flexibility. For example, the meat processor can: a) improve the flavor quality of existing products by masking astringent and bitter off-flavors, and/or b) increase the antimicrobial dosage to extend product shelf-life without undermining its flavor.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In addition, the materials, methods, and examples are illustrative only and not intended to be limiting. All publications, patent applications, patents, and other references mentioned herein are incorporated by reference in their entirety. In case of conflict, the present specification, including definitions, will control.

Details of one or more embodiments of the invention are set forth in the accompanying tables, drawings (if any), and the description herein. Other features, objects, and advantages of one or more embodiments of the invention will be apparent from the description, tables, and drawings (if any), and from the claims.

The following provides additional description of aspects associated with one, or some embodiments of the invention.
1. Useful meat physical forms include, but are not limited to the following examples: whole muscle meat, restructured meat, ground meat, emulsified meat, mechanically deboned meat, hot deboned meat, vascular rinsed meat, and other similar meat physical forms.
2. Useful meats also include those treated using various techniques, such as, but not limited to the following examples: cured meat, uncured meat, smoked meat, fermented meat, frozen meat, unfrozen meat, refrigerated meat, extruded meat, irradiated meat, high pressure processed meat, and other similar meats.
3. Useful post-mortem meat conditions include, but are not limited to the following examples: prerigor meat, postrigor meat, pale soft exudative (PSE) meat, dark firm dry (DFD) meat, and meat in other similar conditions.
4. Useful meat product variations include, but are not limited to the following types of examples: deli meat, sausage, salami, pepperoni, frankfurters, bologna, bacon, ham, and other similar product variations.
5. Within the scope of the invention, the following variations can also be used:
   a) Alternative ingredient order of addition including but not limited to adding trehalose and/or the preservatives before or after cooking the meat.
   b) Alternative methods of delivering trehalose into the meat including but not limited to injection, spraying, surface application, submersion, vascular infusion, pressurization, dry blending, preblending, etc.
   c) Other meat preservatives including but not limited to propionate, glucono-delta-lactone, lactoferrin, nitrite, nitrate, salt, spices, etc.
   d) Other commonly used meat ingredients including but not limited to binders, extenders, alginates, starches, cyclodextrins, seasonings, carageenans, gums, fiber, bread crumbs, vegetable proteins, dairy proteins, hydrolyzed vegetable proteins, hydrolyzed dairy proteins, soy flour, soy isolate, caseinates, whey, egg whites, egg yolks, cereals, rice, wild rice, phosphates, yeast cultures, lactose, dextrose, sucrose, corn syrup, corn syrup solids, disaccharides, bone extracts, antioxidants, stabilizers, etc.
   e) Other common cooking techniques including but not limited to dry methods, wet methods, evacuated bags, smokehouse, water bath, home oven, industrial oven, impingement oven, grills, griddles, rotisserie, etc.
6. According to some embodiments, the following ingredient concentrations could be used: trehalose greater than 0% and less than or equal to about 5%, by weight; sodium lactate greater than 0% and less than or equal to about 5%, by weight; potassium lactate greater than 0% and less than or equal to about 5% by weight; and sodium diacetate greater than 0% and less than or equal to about 1% by weight. In addition, it is not beyond the scope of the invention to use higher amounts of at least some of the ingredients mentioned in this paragraph.
7. According to some embodiments, the invention should allow the shelf-life and food safety of the meat to be improved by expanding the usage of meat preservatives. Typically, meat processors must find a compromise between the meat shelf-life and the meat flavor due to the off-flavors contributed by the preservatives. This invention can allow the use of higher preservative dosages to improve meat shelf-life without adversely affecting the meat flavor.
8. Raw meat containing preservatives and trehalose can also be used.

A brief list of embodiments of the invention includes—but is not restricted to—the following items
1. A food composition comprising meat, trehalose and sodium lactate.
2. A food composition comprising meat, trehalose and potassium lactate.
3. A food composition comprising meat, trehalose and sodium diacetate.
4. The food composition of item 1, wherein the food composition also comprises sodium diacetate.
5. The food composition of item 2, wherein the food composition also comprises sodium diacetate.
6. The food composition of item 1, wherein the trehalose and sodium lactate are substantially distributed throughout the meat.
7. The food composition of item 2, wherein the trehalose and potassium lactate are substantially distributed throughout the meat.
8. The food composition item 3, wherein the trehalose and sodium diacetate are substantially distributed throughout the meat.
9. The food composition of item 4, wherein the trehalose, sodium lactate, and sodium diacetate are substantially distributed throughout the meat.
10. The food composition of item 5, wherein the trehalose, potassium lactate, and sodium diacetate are substantially distributed throughout the meat.
11. The food composition of item 4 or item 5, wherein the meat comprises poultry.
12. The food composition of item 11, wherein the poultry is turkey.
13. The food composition of item 4 or item 5, wherein the meat comprises beef.
14. The food composition of item 4 or item 5, wherein the meat comprises pork.
15. The food composition of item 4 or item 5, wherein the meat comprises an item selected from the group consisting of fish, frankfurter, processed meat, comminuted meat, sausage, deli meat, salami, pepperoni, bologna, bacon, ham, whole muscle meat, restructured meat, ground meat, and emulsified meat.
16. The food composition of item 4, wherein the concentration of the trehalose is about 5% or less on a weight/weight basis, the concentration of the sodium lactate is about 5% or less on a weight/weight basis, and the concentration of the sodium diacetate is about 1% or less on a weight/weight basis.
17. The food composition of item 5, wherein the concentration of the trehalose is about 5% or less on a weight/weight basis, the concentration of the potassium lactate is about 5% or less on a weight/weight basis, and the concentration of the sodium diacetate is about 1% or less on a weight/weight basis.
18. The food composition of item 4 or item 5, wherein the food composition is cooked.
19. A method of treating uncooked meat having one or more preservatives comprising:
   (a) adding trehalose to uncooked meat to create a food composition having less off-flavor when cooked than the same food composition without trehalose.
20. A method of treating uncooked meat with trehalose comprising:
   (a) adding trehalose and one or more preservatives to uncooked meat to create a food composition having less off-flavor when cooked than the same food composition without trehalose.
21. A method of treating uncooked meat with trehalose comprising:
   (a) adding trehalose to uncooked meat; and
   (b) adding one or more preservatives to the uncooked meat
   wherein a food composition is created having less off-flavor when cooked than the same food composition without trehalose.
22. A method for using trehalose to reduce off-flavor of a cooked food composition, comprising:
   (a) adding trehalose to uncooked meat having one or more preservatives; wherein an uncooked food composition is created;
   (b) cooking the uncooked food composition, wherein a cooked food composition is created, and wherein the cooked food composition has less off-flavor than it would have had, if zero trehalose been added in step (a).
23. A method for using trehalose to reduce off-flavor of a cooked food composition, comprising:
   (a) adding trehalose and one or more preservatives to uncooked meat;
   wherein an uncooked food composition is created;
   (b) cooking the uncooked food composition, wherein a cooked food composition is created, and wherein the cooked food composition has less off-flavor than it would have had, if zero trehalose been added in step (a).
24. A method for using trehalose to reduce off-flavor of a cooked food composition, comprising:
   (a) adding trehalose to uncooked meat;
   (b) adding one or more preservatives to the uncooked meat, wherein an uncooked food composition is created;
   (c) cooking the uncooked food composition, wherein a cooked food composition is created, and wherein the cooked food composition has less off-flavor than it would have had, if zero trehalose been added in step (a).
25. The method of item 19, item 20, or item 21, wherein the one or more preservatives comprises sodium lactate.
26. The method of item 19, item 20, or item 21, wherein the one or more preservatives comprises potassium lactate.
27. The method of item 19, item 20, or item 21, wherein the one or more preservatives comprises sodium diacetate.
28. The method of item 19, item 20, or item 21, wherein the one or more preservatives comprises sodium lactate and sodium diacetate.
29. The method of item 19, item 20, or item 21, wherein the one or more preservatives comprises potassium lactate and sodium diacetate.
30. The method of item 19, item 20, or item 21, wherein the off-flavor which the cooked food composition would have had, if it been cooked without the addition of the trehalose, would have been at least in part caused by the one or more preservatives.
31. The cooked food composition resulting from the process of item 19, item 20, or item 21.
32. A food composition for animal consumption, comprising meat, trehalose, sodium lactate, and sodium diacetate.
33. A food composition for animal consumption, comprising meat, trehalose, potassium lactate, and sodium diacetate.
34. A composition comprising sodium lactate, sodium diacetate, and trehalose.
35. The composition of item 34, wherein the composition is an antimicrobial agent.
36. The composition of item 35, wherein the antimicrobial agent is used to preserve food.
37. The composition of item 36, wherein the food comprises meat.
38. A composition comprising potassium lactate, sodium diacetate, and trehalose.
39. The composition of item 38, wherein the composition is an antimicrobial agent.
40. The composition of item 39, wherein the antimicrobial agent is used to preserve food.
41. The composition of item 40, wherein the food comprises meat.
   Examples of Uses of Trehalose as a Flavor Enhancer in Non-Standardized Meat Products

Summarized briefly below are studies demonstrating that in ready-to-eat meat and poultry products, the incorporation of trehalose, e.g. at levels ranging from 1-2%, can mask off-flavors due to sodium lactate, potassium lactate and sodium diacetate. The studies also show that trehalose can effectively mask off-flavors related to salt and sodium phosphate.
Example I Summary: Preliminary study with cooked turkey breast
   Preliminary flavor enhancement studies involving trehalose were conducted by meat scientists at Cargill's Springdale turkey facility. The objective was to determine if trehalose reduced or eliminated metallic, acetate, bitter or astringent off-flavors associated with potassium lactate and sodium diacetate usage. Findings from these studies showed that trehalose reduced or eliminated the metallic flavor and the acetate flavor of potassium lactate and sodium diacetate, respectively. Trehalose was also shown to reduce or eliminate bitter, astringent, and metallic off-flavors associated with salt and sodium phosphate, as well.
Example 2 Summary: Consumer panel sensory evaluation of sliced turkey breast
   Sensory panel studies were conducted to help verify the preliminary results discussed above. The objective was to determine if consumer panelists could detect a difference when turkey breast containing potassium lactate and sodium diacetate was treated with trehalose. Two difference test methodologies were employed; a 2 level AFC test and a triangle test.
   In the 2 level AFC test, panelists were given three samples to taste: a constant reference (without trehalose) and two additional samples (one with trehalose and one without trehalose). Panelists were then asked to identify which of the two additional samples matched the overall meat attributes of the reference. In this study, the panelist detected a borderline difference (p<0.07) when trehalose was added to turkey breast.
   In the triangle test, panelists were given three samples in random order to taste: two of the same sample and one that was different. Panelists were then asked to evaluate the overall attributes and identify the odd sample. In this study, the panelists detected a significant difference (p<0.04) when trehalose was added to turkey breast.
Example 3 Summary: Consumer panel sensory evaluation of sliced roast beef
   Two 2AFC difference tests were conducted to evaluate trehalose flavor enhancement in beef and specifically focused on flavor and aftertaste masking. The first study showed that sodium lactate and sodium diacetate addition changed the flavor and aftertaste of roast beef (p<0.01). The second study showed that flavor and aftertaste associated with the preservatives could be changed by addition of trehalose (p<0.01). So together, the two studies showed that trehalose masks off-flavors associated with lactate and diacetate salts to enhance meat flavor.
      Trehalose Turkey Flavor Study: Example #1
      Title:

Opportunities for Trehalose to Improve the Flavor of Cooked Turkey Breast

Executive Summary:

Trehalose improved the flavor of cooked turkey breast in preliminary flavor studies at the Springdale, Ark. turkey pilot plant. Trehalose (at a level of 2%, by weight of the uncooked product) reduced or eliminated metallic, acetate, bitter, and astringent off-flavors without adding sweetness. It was effective on off-flavors originating from a variety of meat ingredients including potassium lactate, sodium diacetate, salt, and sodium phosphate. Thus, trehalose is a potential new tool for improving the flavor and formulation flexibility of ready-to-eat meat products.

Technical Abstract:

The potential for trehalose to control off-flavor from potassium lactate and sodium diacetate in cooked meat products was investigated. Turkey breast meat was selected as the meat system because its mild flavor background helped accentuate any objectionable flavors. The products were produced at the Springdale, Ark. turkey pilot plant and evaluated by a turkey meat scientist. The addition of 2% trehalose eliminated the metallic flavor and reduced the acetate flavor associated with potassium lactate and sodium diacetate, respectively. Additional studies also revealed that trehalose was effective against off-flavors related to salt and sodium phosphate. Specifically, trehalose reduced salt-induced bitterness (at 1.50-1.75% salt), metallic flavors, and astringency associated with phosphates (at 0.5% sodium phosphate).

Introduction:

Sodium- and potassium lactate are preservatives that have been used to control spoilage and ensure the safety of cooked, ready-to-eat meat products. More recently its been discovered that lactate salts are even more effective against Listeria monocytogenes when combined with sodium diacetate. Thus, the use of lactate and diacetate salts is expected to rise in cooked, ready-to-eat meat products.

However, there are certain flavor drawbacks when adding lactate and diacetate salts to meat. Lactate salts, and especially potassium lactate, are inherently metallic, astringent, and bitter in flavor. Also, sodium diacetate has a vinegar-like flavor due to the acetate content. Thus, meat processors must try to strike a balance between the flavor of the product and its food safety. This means that some off-flavors may be unavoidable if higher preservative dosages are required.

Trehalose has been shown to reduce bitter flavors from potassium salts in high intensity sweeteners, and other similar ingredients. However, the authors of this study are unaware of any similar benefits to flavor in meat. Therefore, the objective of this study was to evaluate the potential for trehalose to mask off-flavors from lactate and diacetate salts in meat.

Materials and Methods:

Ingredients. The ingredients were obtained from Cargill's Springdale, Ark. turkey plant ingredient inventory. They consisted of raw turkey breast meat, sodium chloride (salt), sodium phosphate (STP), dextrose, potassium lactate, and sodium diacetate. The only exception was trehalose, which was purchased from Hayashibara (Japan).

Preparation of Cooked Turkey Breast. Raw, whole turkey breasts were injected with brine solution containing water, salt, STP, potassium lactate, sodium diacetate, and dextrose or trehalose. The meat was injected to a pump level of 33% above the raw meat weight. The injected meat was tumbled at 8 rpm under vacuum (29 in Hg) for 1.5 hours at 40° F. The tumbled meat was then held at 34° F. for 12 to 24 hours before cooking. The formulas are given in Table 1 and show that dextrose was replaced with trehalose while holding the other ingredients constant. The only exception was water level, as it was reduced to accommodate the addition of trehalose.

TABLE 1
The Concentration of Meat Ingredients
Following Injection and Tumbling.

| | Concentration (% by weight) | | | |
|---|---|---|---|---|
| Ingredient | 1 | 2 | 3 | 4 |
| Whole Turkey Breast | 75 | 75 | 75 | 75 |
| Water | 19 | 19 | 18 | 17 |
| Salt | 1.25 | 1.25 | 1.25 | 1.25 |
| STP (Sodium Phosphate) | 0.35 | 0.35 | 0.35 | 0.35 |
| Potassium Lactate | 3.3 | 3.3 | 3.3 | 3.3 |
| (60%) | | | | |
| Sodium Diacetate | 0.1 | 0.1 | 0.1 | 0.1 |
| Dextrose | 1 | 0 | 0 | 0 |
| Trehalose | 0 | 1 | 2 | 3 |
| Total | 100 | 100 | 100 | 100 |

Prior to cooking, the meat was transferred to polyethylene cook bags, evacuated, and then sealed. Cooking was performed in a convection oven (100% relative humidity air) to an internal temperature of 161° F. This was accomplished using the following step-wise temperature gradient: 140° F. (30 minutes), 155° F. (30 minutes), 170° F. (30 minutes), and 180° F. (to the endpoint temperature). Following cooking, the samples were chilled in a cold water shower and refrigerated (34° F.) overnight prior to flavor evaluation.

Flavor Evaluation. The cooked turkey breasts were sliced into 2-3 mm thick slices to facilitate flavor analysis. The flavor of each product was then evaluated by a Cargill turkey meat scientist. The presence and relative intensity of metallic, bitter, astringent, acetate, and sweet flavors were judged.

Results and Discussion:

Potassium lactate and sodium diacetate are routinely added to turkey breast meat to control spoilage and increase product safety. However, they can also contribute some undesirable flavors to the meat. Specifically, potassium lactate has metallic and bitter off-flavors while sodium diacetate contributes vinegar-like flavor (acetate). These flavors are especially noticeable in turkey breast because the meat background flavor is bland, as compared to more savory meat like beef or pork.

The effect of trehalose on the flavor of sliced turkey breast is shown below in Table 2. The dextrose-containing product had obvious metallic and acetate off-flavors, as expected, but it wasn't noticeably bitter. Replacing dextrose with trehalose (1%) masked the metallic flavor and increasing trehalose further (to 2%) reduced the acetate flavor. The flavor improvement was achieved without creating excess sweetness above the level of the control (“standard” level). Further increasing trehalose (to 3%) had similar effects on metallic and acetate flavors but the sweetness increased above the control level (“above standard”). Overall, the flavor of meat containing 2% trehalose was preferred over the other products, including the commercial product with dextrose. The scope of the invention, however, includes compositions containing greater than 2% trehalose. Further, it is contemplated that trehalose could be used in combination with ingredients that may mask or counteract excess sweetness if desired.

TABLE 2
The Effect of Trehalose on Metallic and
Acetate Off-Flavors in Turkey Breast.

| | Dextrose | | | | |
|---|---|---|---|---|---|
| | or | | | | Overall |
| ^{a}Formula | Trehalose | Flavors Detected | | | Preference |
| # | Level | Metallic | Acetate | Sweetness | Ranking |
| 1 | 1% | Detected | Detected | Standard | 3 |
| | Dextrose | | | | |
| 2 | 1% | Not | Detected | Standard | 2 |
| | Trehalose | Detected | | | |
| 3 | 2% | Not | Slightly | Standard | 1 |
| | Trehalose | Detected | Detected | | |
| 4 | 3% | Not | Slightly | Above | 3 |
| | Trehalose | Detected | Detected | standard | |

^{a}Formulas are shown in Table 1.

A common practice used by the meat industry, to increase cook yield or mask metallic and acetate flavors, is to increase the salt levels. But adding salt raises the sodium content and can create bitterness. We investigated whether trehalose might help control bitterness when higher salt levels are present. The product formulas are presented in Table 3 and the results are shown in Table 4. Raising the salt level (to 1.5% or higher) masked the metallic flavor but added bitterness. Trehalose (2%) helped reduce the bitterness but didn't completely eliminate it. However, the overall flavor of trehalose-containing products again was preferred over the products containing dextrose.

TABLE 3
The Formulas for Turkey Breasts Injected
with Higher Salt Levels.

| | Concentration (% by weight) | | | | | |
|---|---|---|---|---|---|---|
| Ingredient | 1 | 2 | 3 | 4 | 5 | 6 |
| Turkey | 75 | 75 | 75 | 75 | 75 | 75 |
| Breast | | | | | | |
| Water | 19 | 18 | 17.75 | 17.75 | 17.5 | 17.5 |
| Salt | 1.25 | 1.25 | 1.5 | 1.5 | 1.75 | 1.75 |
| STP | 0.35 | 0.35 | 0.35 | 0.35 | 0.35 | 0.35 |
| KLactate | 3.3 | 3.3 | 3.3 | 3.3 | 3.3 | 3.3 |
| (60%) | | | | | | |
| NaDiacetate | 0.1 | 0.1 | 0.1 | 0.1 | 0.1 | 0.1 |
| Dextrose | 1 | 0 | 2 | 0 | 2 | 0 |
| Trehalose | 0 | 2 | 0 | 2 | 0 | 2 |
| Total | 100 | 100 | 100 | 100 | 100 | 100 |

TABLE 4
The Effect of Trehalose on Metallic and Bitter Off-Flavors
in Turkey Breasts Injected with Higher Salt Levels.

| | Flavors Detected | | | |
|---|---|---|---|---|
| | Metallic | | Bitterness | |
| Salt (%) | Dextrose | Trehalose | Dextrose | Trehalose |
| ^{a}1.25 | Detected | Not | Not | Not Detected |
| | | Detected | Detected | |
| ^{b}1.50 | Not | Not | Detected | Slightly Detect |
| | Detected | Detected | | |
| ^{c}1.75 | Not | Not | Detected | Slightly Detect |
| | Detected | Detected | | |

^{a}Formulas 1 and 2 in Table 3.
^{b}Formulas 3 and 4 in Table 3.
^{c}Formulas 5 and 6 in Table 3.

Another technique used to improve cook yields is to increase the sodium phosphate content. The USDA has established an upper limit of 0.5% sodium phosphate, but lower levels are commonly added because metallic flavors can develop. We ran studies to determine whether trehalose might help improve the flavor of turkey breast when sodium phosphate was present at the maximum level permitted. The product formulas are presented in Table 5 and the results are shown in Table 6.

Increasing sodium phosphate to 0.5% created a metallic flavor that didn't exist at 0.35% (see Table 4, 1.75% salt with dextrose). Also, bitterness did not change but a new off-flavor (astringent) appeared which had not been observed in the previous studies. However, when dextrose was replaced by trehalose, the metallic flavor was not detected and the product had much less astringent flavor.

In conclusion, trehalose reduced or eliminated metallic, acetate, bitter, and astringent off-flavors originating from a variety of meat ingredients (potassium lactate, sodium diacetate, salt, and sodium phosphate) without adding excess sweetness. In each study, the overall flavor of the trehalose-containing product was preferred over the current product with dextrose. These results suggest that trehalose may provide a complementary functionality in meat systems that helps increase formulation flexibility, and ultimately product quality.

TABLE 5
The Formulas for Turkey Breasts Injected
with Higher Phosphate (STP) Levels.

Concentration (% by weight)

| Ingredients | 1 | 2 |
|---|---|---|
| Turkey Breast | 75 | 75 |
| Water | 16.75 | 16.75 |
| Carrageenan | .6 | .6 |
| Salt | 1.75 | 1.75 |
| STP | .5 | .5 |
| KLactate (60%) | 3.3 | 3.3 |
| NaDiacetate | 0.1 | 0.1 |
| Dextrose | 2 | 0 |
| Trehalose | 0 | 2 |
| Total | 100 | 100 |

TABLE 6
The Effect of Trehalose on Metallic, Bitter, and Astringent Off-Flavors
in Turkey Breasts Injected with Higher Phosphate Levels.
Flavors Detected

| Metallic | | Bitterness | | Astringent | |
|---|---|---|---|---|---|
| ^{a}Dextrose | ^{b}Trehalose | ^{a}Dextrose | ^{b}Trehalose | ^{a}Dextrose | ^{b}Trehalose |
| Detected | Not Detect | Detected | Slight | Detected | Slight |
| | | | Detect | | Detect |

^{a}Formula 1 in Table 5.
^{b}Formula 2 in Table 5.

Trehalose Turkey Flavor Study: Example #2

This report contains the results and analysis of the two sensory difference tests performed on the samples described below.

Title:

Trehalose as a Masking Agent for Off-Flavors in Ready-to-Eat Processed Meat

Summary

Testing with 2-4 turkey breast samples revealed that the 2% trehalose treatment produced a borderline significant difference (p=0.07) or a significant difference (p=0.04) from the control (1% dextrose).

Samples

Two sets of samples were prepared at the Cargill Turkey Pilot Plant. The control contained 1% dextrose and the trehalose samples contained 2% trehalose in place of the dextrose. The formulas are shown below in Table 2.1.

TABLE 2.1
The Concentration of Ingredients Present in the Turkey Breasts.

Concentration (% by weight)

| Ingredient | 1 | 2 |
|---|---|---|
| Whole Turkey Breast | 75 | 75 |
| Water | 19 | 18 |
| Salt | 1.25 | 1.25 |
| STP | 0.35 | 0.35 |
| Potassium Lactate (60%) | 3.3 | 3.3 |
| Sodium Diacetate | 0.1 | 0.1 |
| Dextrose | 1 | 0 |
| Trehalose | 0 | 2 |
| Total | 100 | 100 |

Sample Preparation

Raw, whole turkey breasts were injected with brine solution containing water, salt, STP, potassium lactate, sodium diacetate, and dextrose or trehalose. The meat was injected to a pump level of 33% above the raw meat weight. The injected meat was tumbled at 8 rpm under vacuum (29 in Hg) for 1.5 hours at 40° F. The tumbled meat was then held at 34° F. for 12 to 24 hours before cooking. The formulas are given in Table 1 and show that dextrose was replaced with trehalose while holding the other ingredients constant. The only exception was water level, as it was reduced to accommodate the addition of trehalose.

Prior to cooking, the meat was transferred to polyethylene cook bags, evacuated, and then sealed. Cooking was performed in a convection oven (100% relative humidity air) to an internal temperature of 161° F. This was accomplished using the following step-wise temperature gradient: 140° F. (30 minutes), 155° F. (30 minutes), 170° F. (30 minutes), and 180° F. (to the endpoint temperature). Following cooking, the samples were chilled in a cold water shower and refrigerated (34° F.) prior to flavor evaluation.

Sensory Analysis

The difference test methods can be found in “Sensory Analysis Techniques” 3rd edition. Meilgaard, Civille, Carr.

Two Level Alternative Forced Choice Method (2AFC): A duo-trio test was run and the control product (formula #1 in Table 1) was used as the constant reference.

Sample Preparation:

Samples from each breast were taken by using a typical deli meat-slicer, and the panelist received the whole slice.

Sensory Protocol:

The following standard duo-trio protocol was used in the tests.
1) Panelists were given one sample, the reference sample, and asked to note its overall attributes.
2) Panelists were then given two additional samples, one sample that matched the reference, and one sample that did not match the reference.
3) Panelists were asked to evaluate the samples in the order presented on the tray (left to right) and identify the sample that matched the reference.
4) Water and spit cups were provided for each panelist.

The design was balanced with respect to both presentation order and use of reference sample.

Triangle Test:

The panelists were given three samples and instructed that two samples are identical and one is different. The subjects were then asked to evaluate the overall attributes of each sample from left to right and select the odd sample.

Test 1: 2 Level AFC Difference Test

The first test was a 2 level AFC with control turkey breasts (2 sample breasts) and turkey breast with 2% added trehalose (2 sample breasts)

Panel: Panelists consisted of individuals who had no problems eating sliced turkey products.

Sample Preparation: Samples were sliced using a food service-type meat slicer to a thickness of about 1 MM. Samples were refrigerated at 35 F to 40 F before serving.

Experimental Design: No blocks were used. The current product (control) was used as the constant reference. Tray order was rotated.

Results:

Of the 67 panelists, 40 identified the correct sample, which gives a p-value of 0.07. That means we cannot declare the two samples significantly different at the 95% significance level, but we can declare them significantly different at the 90% significance level.

Test 2: Triangle Difference Test

The second test was a triangle test with samples from four breasts for both the control and 2% trehalose treatment.

Panel: Panelists consisted of individuals who had no problems eating sliced turkey products.

Sample Preparation: Samples were sliced using a food service-type meat slicer to a thickness of about 1 MM. Samples were refrigerated at 35 F to 40 F before serving.

Experimental Design: no blocks, rotated tray presentations

Results:

Of the 68 panelists, 30 correctly identified the odd sample, which gives a p-value of 0.04. The 95% confidence interval on the percent discriminators was 1% to 31%, significantly greater than 0.

Trehalose Beef Flavor Study: Example #3

Title:

Sensory Analysis of Trehalose and Preservatives in Roast Beef Products

Summary:

This study was undertaken in order to test the ability of trehalose to mask the flavor and aftertaste associated with the preservatives sodium lactate and sodium diacetate in roast beef.

As a first step, a duo-trio test was used to establish that panelists could discriminate between the control roast product and a roast product with reduced preservatives. In this test 45 of the 68 panelists, 66%, selected the correct sample, which is greater than 50% (p<0.01) meaning panelists were able to identify when the preservatives were reduced.

Next, a duo-trio test was used to establish that panelists could discriminate between the control roast and the roast with trehalose as a replacement for dextrose. In this test 50 of 66 panelists, 76%, selected the correct sample. This is greater than 50% (p<0.01) meaning panelists were able to identify when trehalose was used to replace dextrose.

Scientific Objective:

The scientific objective of these experiments was to estimate the ability of consumers to discriminate between current roast beef products with and without trehalose.

Materials and Methods:

Samples:

The formulas for the roast beef products used in both tests are given in Table 1 below.

TABLE 1
Roast Beef Formulas.
PRODUCT FORMULATION

| | | | Control with |
|---|---|---|---|
| | | Control with | Trehalose |
| | | reduced | instead of |
| INGREDIENT | Control | preservatives | dextrose |
| Beef Top Rounds | 80 | 80 | 80 |
| Water | 15.05 | 16.55 | 13.85 |
| Sodium Lactate | 1.4 | 0 | 1.4 |
| Sodium Diacetate | 0.1 | 0 | 0.1 |
| Beef Flavoring | 1 | 1 | 1 |
| Dextrose | .8 | .8 | 0 |
| Trehalose | 0 | 0 | 2 |
| Salt | 0.8 | 0.8 | 0.8 |
| Hydrolyzed Soy Protein | 0.5 | 0.5 | 0.5 |
| Sodium Phosphate | 0.35 | 0.35 | 0.35 |
| TOTAL | 100 | 100 | 100 |

Note that the control product had 15.05% water and 0.8% dextrose, and the product with trehalose had 13.85% water and 2% trehalose. (There was not a 1-1 trehalose-dextrose replacement).

Sample Preparation and Cooking:

The roasts were prepared using fresh utility-grade cap-off inside top rounds. A brine solution was prepared by mixing sodium phosphate with water followed by sodium lactate, sodium diacetate, beef flavoring, dextrose, trehalose, salt, and hydrolyzed soy protein. The roasts were injected with brine to increase their weight by 25% (25% over green weight). The injected roasts were then tumbled at 5 rpm for 60 minutes at 40° F. under vacuum (−1 bar) to distribute brine evenly throughout the muscle. Tumbled roasts were then transferred into polyethylene bags, evacuated, sealed, and then chilled overnight prior to cooking. The roasts were submerged in hot water (165° F.) and cooked to an internal temperature of 152° F. Cooked roasts were then held at about 40° F. prior to sensory analysis.

Sensory Analysis:

Two separate duo-trio tests were run. The first test used roast beef products with and without preservatives. The second test used the control roast beef product and the control product with dextrose replaced by trehalose.

Sample Preparation:

In both tests, four roasts of each formulation were used. An equal number of slices were taken from each roast and used in the test. Samples from each roast were taken by using a typical deli meat-slicer, and the panelist received the whole slice.

Sensory Protocol:

The following standard duo-trio protocol was used in both tests and is referenced in “Sensory Analysis Techniques” 3rd edition. Meilgaard, Civille, Carr.
1) Panelists were given one sample, the reference sample, and asked to note the flavor and aftertaste.
2) Panelists were then given two additional samples, one sample that matched the reference, and one sample that did not match the reference.
3) Panelists were asked to evaluate the samples in the order presented on the tray (left to right) and identify the sample that matched the reference.
4) Water and spit cups were provided for each panelist.

The design was balanced with respect to both presentation order and use of reference sample.

The actual question given to the panelists is shown below.

Instruction

You will be given two samples to compare to a reference.
In this test we want you to focus only on the FLAVOR and
AFTERTASTE of these samples when you make your comparison.
Please ignore any other differences in the product
(saltiness, juiciness, etc)
Please taste the REFERENCE and remember its FLAVOR and
AFTERTASTE
Then taste the samples.
Then tell us which of the two samples is MOST LIKE the
REFERENCE in FLAVOR and AFTERTASTE

Results:

In the first test, a statistically significant (p<0.01) percent of the panelists, 66% (45 of 68) correctly matched the reference sample. This translates to 32% of the population being able to distinguish between the products with 90% confidence limits of 13%-51%. From this we conclude that about ⅓ of the general population can tell the difference in flavor and aftertaste between the control and reduced-preservative product.

In the second test, a statistically significant (p<0.01) percent of the panelists, 76% (50 of 66) correctly matched the reference sample. This translates to 52% of the population being able to distinguish between the products with 90% confidence limits of 34%-69%. From this we conclude that about half of the general population can tell the difference in flavor and aftertaste between the control and control with dextrose replaced by trehalose.

Listing of Ingredient Names and Suppliers

### Ingredient Names and Suppliers

### Beef Ingredient Names and Suppliers

| Common | | | |
|---|---|---|---|
| Name | Chemical Name | Product Name | Supplier |
| Beef Top | N/A | Utility Grade Cap- | N/A |
| Rounds | | Off Inside Beef | |
| | | Top Rounds | |
| Water | Water | Water | N/A |
| Sodium | Sodium Lactate | Purasal Opti. form | PURAC |
| Lactate | | 4 | |
| Sodium | Sodium Diacetate | Purasal Opti. form | PURAC |
| Diacetate | | 4 | |
| Beef Flavor | Hydrolyzed soy | Sensient Liquid | Sensient |
| | and corn proteins, | Beef Flavor for | Flavors |
| | natural flavors | Emmpak | |
| Dextrose | Dextrose | Dextrose | Clintose |
| Trehalose | Trehalose | Trehalose | Hayashibara |
| | | | International |
| Salt | Sodium Chloride | Sodium Chloride | Cargill, Inc. |
| Hydrolyzed | Hydrolyzed Soy | HVF-53 | Solae |
| Soy Protein | Protein | | |
| Sodium | Sodium | Nutrifos 330 | Astaris |
| Phosphate | Polyphosphate | | |
| Rub | Maltodextrin, | #11825201 | UBF Solutions |
| | Dextrose and | | |
| | Caramel Color | | |

| Common | | | |
|---|---|---|---|
| Name | Chemical Name | Product Name | Supplier |
| Turkey Breast | N/A | Turkey Breast | N/A |
| Meat | | Meat | |
| Water | Water | Water | N/A |
| Salt | Sodium Chloride | Sodium Chloride | Cargill, Inc. |
| Sodium | Triphosphoric | Nutrifos 088 | Astaris |
| Phosphate | Acid, | | |
| | Pentasodium Salt | | |
| Potassium | Potassium Lactate | Purasal P | PURAC |
| Lactate | | | |
| Sodium | Sodium Diacetate | Sodium Diacetate | Jungbunzlauer |
| Diacetate | | | |
| Dextrose | Dextrose | STALEYDEX 333 | A. E. Staley |
| | | Dextrose | |
| Trehalose | Trehalose | Trehalose | Hayashibara |
| | | Trehalose | International |

Calculation of Percent Discriminators

### Calculation of the Percent Discriminators

These notes are from Sensory Evaluation Techniques 3^{rd} edition by Meilgaard, Civille and Carr, especially pages 66 and 74.

| Quantity | Triangle | Duo-trio |
|---|---|---|
| Probability of correct | 1/3 | 1/2 |
| guess (p_{g}) | | |
| Proportion correct (p_{c}) | c/n | c/n |
| Proportion distinguishers | 1.5*p_{c} − 0.5 | 2*p_{c} − 1.0 |
| (p_{d}) | | |
| Standard dev of p_{d} (s_{d}) | 1.5*sqrt(p_{c}(1 − pc)/n) | 2*sqrt(p_{c}(1 − p_{c})/n) |
| Upper CL | p_{d} + z*s_{d} | p_{d} + z*s_{d} |
| Lower CL | p_{d} − z*s_{d} | p_{d} − z*s_{d} |

The general equation for the proportion distinguishers is

$${p}_{d} = \frac{{p}_{c} - {p}_{g}}{1 - {p}_{g}} ,$$

This is based on the idea that the percent correct is the sum of those that can discriminate and those that guessed.
p_{c}=p_{d}+(1−p_{d})p_{g}

Additional testing was performed to estimate the ability of consumers to discriminate between current roast beef products with and without trehalose and current roast turkey breast products with and without trehalose. Example 7 illustrates a preference test, in which a consumer sensory panel was asked to discriminate between a roast turkey breast with and without trehalose. In this test, the control scored significantly better than with trehalose product. Example 4 provides an additional duo-trio test, in which a consumer panel was asked to discriminate between a roast beef and a roast beef with reduced preservatives. Results suggested that the panelists could not differentiate the control from the test product. Studies were then undertaken to analyze the discrepancy in results between Examples 1-3 and 4. Specifically, the protocol of the standard tests was modified to remove variables that might interfere with a panelist's ability to distinguish taste differences, in order to examine whether consumer panelists could in fact identify relevant taste differences. Examples 5 and 9 suggest that untrained consumers cannot identify taste differences between a control meat and meat with reduced preservatives, even with a test designed to help such consumers sense differences in taste. Consequently it was not surprising that the untrained consumers could not discriminate between meat with and without trehalose using the same modified protocols, as shown in Examples 6, 8, and 10.

### Example 7

### Roast Turkey Preference Test

This test combined hedonic, preference and demographic questions. The panelists consisted of individuals who had no problems eating sliced turkey products. Samples were sliced using a food service-type meat slicer to a thickness of about 1 MM. Samples were refrigerated 35 F to 40 F before serving.

Sample Description: the sample composition was according to Example 1, table 1. Only the control (1% dextrose) and 2% trehalose treatment were used in Example 7.

Experimental Design: sequential monadic evaluation of two samples. Rotated tray order.

Results:

The table below gives the summary statistics for the hedonic questions. Note that the control product scored significantly higher than the experimental product on “tenderness” and “juiciness”. No other significant differences between the products were found.

TABLE 1
Summary Statistics for Hedonic Questions (n = 98)

| | | Experimental | |
|---|---|---|---|
| | Control | Turkey | |
| Attribute | Turkey Breast | Breast* | P-Value |
| Overall Liking | 7.07 | 6.94 | 0.50 |
| Appearance | 7.07 | 7.20 | 0.43 |
| Aroma | 6.43 | 6.36 | 0.57 |
| Flavor | 6.97 | 6.84 | 0.53 |
| Tenderness | 7.49 | 7.13 | 0.03 |
| Juiciness | 7.51 | 6.87 | <0.01 |
| Aftertaste | 6.10 | 6.12 | 0.92 |

*Turkey breast with 2% trehalose in place of dextrose.

In response to the question: “Which do you prefer?”, 60 of 98 panelists (61%) selected the control turkey breast product. This percent is significantly greater than 50% and means that the percent that preferred the control product was significantly higher than the percent that preferred the experimental product.

A summary of Roast Beef Examples 3-6 is provided below.

Examples 4-6 were run in order to verify the results seen in Example 3 and to compare samples with reduced preservative and samples with trehalose.

| Test | | | Results | |
|---|---|---|---|---|
| Date | Comparison | Type | Correct/N | Conclusion |
| Example | Control vs. | Duo- | 45/68 | Panelists can |
| 3, test 1 | reduced | trio | | differentiate |
| | preservatives | | | (p < 0.05) |
| Example | Control vs. | Duo- | 50/66 | Panelists can |
| 3, test 2 | preservatives | trio | | differentiate |
| | with trehalose | | | (p < 0.05) |
| Example 4 | Control vs. | Duo- | 13/65 | Panelists cannot |
| | reduced | trio | | differentiate |
| | preservatives | | | (p > 0.10) |
| Example 5 | Control vs. | Duo- | 12/30 | Panelists cannot |
| | reduced | trio | | differentiate |
| | preservatives | | | (p > 0.10) |
| Example 6 | Control vs. | Duo- | 39/80 | Panelists cannot |
| | preservatives | trio | | differentiate |
| | with trehalose | | | (p > 0.10) |

The Example 4 results led to an investigation of the sample and a subsequent change in methods. Examination of the samples revealed obvious color differences between the roasts, even roasts within the same treatment. In order to reduce the effect of the color, subsequent testing was done under red light with smaller more uniform pieces.

Possible explanations for the discrepancy between the Example 3 results and the Example 4-6 results are genetic and processing variability of the individual roasts or problems with the sensory methods.

Methods:

Samples:

The base roast beef product used in the Examples was Emmber Classic roast beef top rounds using the formulations shown below.

PRODUCT FORMULATION

| | | | Control |
|---|---|---|---|
| | | | with |
| | | Control with | Trehalose |
| | | reduced | instead of |
| INGREDIENT | Control | preservatives | dextrose |
| UT INSIDE, CAP-OFF | 80.00 | 80.00 | 80.00 |
| WATER | 14.05 | 16.55 | 12.85 |
| OPTIFORM 4 (L# 031200590) | 2.50 | 0.00 | 2.50 |
| SENSIENT (L# B671786) | 1.00 | 1.00 | 1.00 |
| DEXTROSE (L# CD3011015) | 0.80 | 0.80 | 0 |
| TREHALOSE | 0.00 | 0.00 | 2.00 |
| SALT (L# B3273) | 0.80 | 0.80 | 0.80 |
| HVF-53 (L# P110007473) | 0.50 | 0.50 | 0.50 |
| SODIUM PHOSPHATE | 0.35 | 0.35 | 0.35 |
| (L# 2230-15643) | | | |
| TOTAL | 100.00 | 100.00 | 100.00 |

Note that the control product had 14.05% water and 0.8% dextrose, and the product with trehalose had 12.85% water and 2.0% trehalose. (There was not a 1-1 trehalose-dextrose replacement.)

Sensory Analysis:

Four separate duo-trio tests were run, and in all tests, the control product was used as the constant reference.

Sample Preparation:

In all tests, four roasts of each formulation were used. An equal number of slices were taken from each roast and used in the test. Samples from each roast were taken by using a typical deli meat-slicer.

In Examples 3 and 4, the panelist received the whole slice. In Examples 5 and 6 the panelist received an interior piece of the slice instead of the whole slice.

Sensory Protocol:

The standard duo-trio protocol described above in connection with Example 3 was also used in Examples 4-6.

Results:

In the Example 3, test 1, a statistically significant (p<0.01) percent of the panelists, 66% (45 of 68) correctly matched the reference sample. This translates to 32% of the population being able to distinguish between the products with 90% confidence limits of 13%-51%. From this we conclude that about ⅓ of the general population can tell the difference in flavor and aftertaste between the control and reduced-preservative product.

In the Example 3, test 2, a statistically significant (p<0.01) percent of the panelists, 76% (50 of 66) correctly matched the reference sample. This translates to 52% of the population being able to distinguish between the products with 90% confidence limits of 34%-69%. From this we conclude that about half of the general population can tell the difference in flavor and aftertaste between the control and control with dextrose replaced by trehalose.

In Example 4, the panelists correctly identified the reference sample. This result was surprising in that significantly fewer than 50% of the panelists correctly identified the reference sample. Examination of the samples revealed large variations in several of the roasts. In addition, the within slice variability of appearance and fat content was high. In order to reduce the effect of these problems, the protocol was changed to have the samples presented under red light, and only a 2″ by 2″ sample used.

Example 5 was a repeat of Example 4 using the new protocol. In this test 12 of 30 correctly identified the reference sample. This means that a significant percent of panelists were not able to tell the difference between the control and the control with reduced preservatives.

In the Example 6, panelists correctly identified the reference sample. This means that panelists were not able to tell the difference between the control and the control with dextrose replaced by trehalose.

Possible explanations for the discrepancy between the Example 3 results and the Example 4-6 results are:
1) Genetic variability
   Since each test uses so few different roasts, the genetic variability from roast to roast can have a huge impact on the results.
2) Problems with the sensory methods
   Changes to the protocol were made to reduce the impact of color differences and within slice variability.
3) Processing variability
   Since the test uses so few different roasts, variability in the amount of solution absorbed by each roast ca have a large impact on the results.

A summary of Roast Turkey examples 2 and 7-10 is provided below.

### Summary of Turkey Tests

| | | | Results | |
|---|---|---|---|---|
| SIMS Test | Comparison | Type | Correct/N | Conclusion |
| Example 2, | Control vs. 2% | Duo-trio | 40/67 | Panelists can |
| test 1 | added trehalose | | | differentiate |
| | | | | (p = 0.07) |
| Example 2, | Control vs. 2% | Triangle | 30/68 | Panelists can |
| test 2 | added trehalose | | | differentiate |
| | | | | (p < 0.05) |
| Example 7 | Control vs. 2% | Preference | 60/98 | Control |
| | added trehalose | | select the | scored sig- |
| | | | control | nificantly |
| | | | | better than |
| | | | | “with tre- |
| | | | | halose” |
| | | | | product. |
| Example 8 | Control vs. 2% | Duo-trio | 38/80 | Panelists |
| | added trehalose | | | cannot dif- |
| | | | | ferentiate |
| | | | | (p > 0.10) |
| Example 9 | Control vs. reduced | Duo-trio | 34/65 | Panelists |
| | preservatives | | | cannot dif- |
| | | | | ferentiate |
| | | | | (p > 0.10) |
| Example 10 | Control vs. 2% | Preference | 41/88 | No clear |
| | added trehalose | | select the | difference in |
| | | | sample | preference. |
| | | | with 2% | |
| | | | added | |
| | | | trehalose | |

Possible explanations for the discrepancy between the first 3 tests and the later tests are genetic variability, processing variability and problems with the sensory methods.

Methods:

sample Preparation and Sensory Testing Protocol:

Samples from each breast were taken by using a typical deli meat-slicer, and the panelist received the whole slice. Standard protocols for duo-trio and preference tests were used, using the ballot described above. Sample preparation and Sensory Protocol for Examples 8-10 were the same as for Examples 2 and 7 except that the meat was sliced into smaller, more uniform pieces of about 2 inches by 2 inches square, and the testing was done under red light. The purpose of these modifications was to assist an untrained consumer in identifying differences in taste by eliminating variables that may hinder their ability to sense taste differences.

Results:

In the Example 8 test, samples were made with the control solution and the control solution with dextrose replaced with 2% trehalose. In this test 38 of the 80 panelists, i.e. 48%, correctly selected the reference sample. This is not significantly greater than 50% (p<0.01) which means panelists were unable to differentiate between the samples. The one-sided 95% confidence limit on the percent distinguishers was a relatively low 13%.

In the Example 9 test, samples were made with the control solution and the control solution with reduced preservatives. In this test 34 of the 65 panelists, 52%, correctly selected the reference sample. This is not significantly greater than 50% (p<0.01) which means panelists were unable to differentiate between the samples. The one-sided 95% confidence limit on the percent distinguishers was 25%.

In the Example 10 test, a preference test was run comparing control samples and samples with dextrose replaced with 2% trehalose. 41/88 (47%) panelists selected the sample with trehalose. This preference test was run instead of a difference test because of inconclusive results in previous difference tests indicated this may be a case of the non-discriminating discriminators paradox. Results of this test indicate that panelists were unable to differentiate between the samples.

### CONCLUSION

The table below provides confidence limits on the percent discriminators from the tests. There is some overlap, but the differences between the two sets (Example 2) and (Examples 8 and 9) are unlikely to be due to chance alone.

### Summary of Tests

| | | | Percent |
|---|---|---|---|
| | | | Discriminators |
| SIMS Test | Comparison | Type | 90% CL |
| Example 2, | Control vs. 2% | Duo-trio | 5%, 34% |
| test 1 | added trehalose | | |
| Example 2, | Control vs. 2% | Triangle | 1%, 31% |
| test 2 | added trehalose | | |
| Example 8 | Control vs. 2% | Duo-trio | <0%, 13% |
| | added trehalose | | |
| Example 9 | Control vs. reduced | Duo-trio | <0%, 25% |
| | preservatives | | |

Possible explanations for the discrepancy in the tests are:
1. Genetic variability and processing variability
   Since the number of different turkey breasts used is so small, just one out of the ordinary breast (either due to genetics or processing) can have a large effect on the trial.
2. Problems with the sensory methods
   The sensory methods were held constant for all tests. Future testing should include some ability to track the breast associated with each sample served.

A number of embodiments of the invention have been described. Nevertheless, it will be understood that various modifications may be made without departing from the spirit and scope of the invention. Accordingly, other embodiments are within the scope of the following claims.

1. A composition comprising meat, trehalose and at least one preservative.

2. A composition according to claim 1, wherein the at least one preservative is at least one antimicrobial agent.

3. A composition according to claim 1, wherein the at least one preservative is chosen from sodium lactate, potassium lactate, and sodium diacetate.

4. A composition according to claim 3, wherein the at least one preservative is at least sodium lactate and potassium lactate.

5. A composition according to claim 3, wherein the trehalose and the preservative are substantially distributed throughout the meat.

6. A composition according to claim 3, wherein the meat comprises poultry.

7. A composition according to claim 6, wherein the poultry is turkey.

8. A composition according to claim 3 wherein the meat comprises beef.

9. A composition according to claim 6, wherein the meat comprises pork.

10. A composition according to claim 3, wherein the meat is chosen from fish, frankfurter, processed meat, comminuted meat, sausage, deli meat, salami, pepperoni, bologna, bacon, ham, whole muscle meat, restructured meat, ground meat, and emulsified meat.

11. A composition according to claim 3, wherein the amount of trehalose in the composition is about 5% by weight of the composition or less.

12. A composition according to claim 11, wherein the amount of trehalose in the composition is about 3% by weight of the composition or less.

13. A composition according claim 12, wherein the amount of trehalose ranges from about 1% by weight to about 3% by weight.

14. A composition according to claim 13, wherein the amount of trehalose is about 2% by weight.

15. A composition according to claim 1, wherein the preservative is sodium diacetate and the preservative also is one of sodium lactate or potassium lactate, wherein the amount trehalose is about 5% by weight or less, the amount sodium lactate or potassium lactate is about 5% by weight or less, and the amount of sodium diacetate is about 1% by weight or less.

16. A composition according to claim 3, wherein the food composition is a cooked food composition.

17. A method of making a food composition, comprising adding a sufficient amount of trehalose to a meat composition comprising at least one preservative to make a food composition having less off-flavor than the meat composition.

18. A method according to claim 17, wherein the food composition is cooked.

19. A method according to claim 17, wherein the at least one preservative is chosen from sodium lactate, potassium lactate, sodium diacetate, and combinations thereof.

20. A method according to claim 17, wherein the amount of trehalose is about 5% or less by weight of the food composition.
